(19) United States
(12) Patent Application Publication
(10) Pub. No.: US 2013/0329318 A1
(43) Pub. Date: Dec. 12, 2013

(54) TAPE RECORDING MEDIUM, INFORMATION RECORDING SYSTEM, AND RECORDING TAPE CARTRIDGE

(71) Applicant: Fujifilm Corporation, Tokyo (JP)

(72) Inventor: Kenji TAKENOSHITA, Odawara-shi (JP)

(73) Assignee: FUJIFILM CORPORATION, Tokyo (JP)

(21) Appl. No.: 13/965,237

(22) Filed: Aug. 13, 2013

Related U.S. Application Data
(63) Continuation of application No. PCT/JP2011/076937, filed on Nov. 22, 2011.

(30) Foreign Application Priority Data
Feb. 17, 2011 (JP) 2011-032185

(51) Int. Cl. G11B 5/41

(52) U.S. Cl. CPC G11B 5/41
USPC 360/91

(57) ABSTRACT

A tape recording medium comprising a reel; recording tape that is wound around the reel and on which information is written or from which information is read while the recording tape is in contact with a head; cleaning tape that is wound around the reel and cleans the head while the cleaning tape is in contact with the head; and protective tape that has one end connected to an end portion of the recording tape and the other end connected to an end portion of the cleaning tape, and that has a length with which the protective tape is wound at least one round around the reel such that the recording tape and the cleaning tape do not contact each other.

### CROSS-REFERENCE TO RELATED APPLICATIONS

This application is a continuation application of International Application No. PCT/JP/2011/076937, filed Nov. 22, 2011, which is incorporated herein by reference. Further, this application claims priority from Japanese Patent Application No. 2011-032185, filed Feb. 17, 2011, which is incorporated herein by reference.

### TECHNICAL FIELD

The present invention relates to a tape recording medium, an information recording system, and a recording tape cartridge in which recording tape and cleaning tape are wound around a reel.

### RELATED ART

For example, as described in JP-A No. 2004-178645, a configuration where traveling tape that is wound around a reel has magnetic tape, terminal end detection tape having one end connected to a tape end portion of the magnetic tape, and cleaning tape connected to the other end of the terminal end detection tape is known.

### SUMMARY OF INVENTION

Incidentally, in a configuration where recording tape and cleaning tape are wound around a reel, protecting the recording tape from the cleaning tape is preferred.

The present invention obtains a tape recording medium, an information recording system, and a recording tape cartridge that can protect recording tape from cleaning tape that is wound around a reel together with the recording tape.

A tape recording medium of a first aspect of the present invention comprises: a reel; recording tape that is wound around the reel and on which information is written or from which information is read while the recording tape is in contact with a head; cleaning tape that is wound around the reel and cleans the head while the cleaning tape is in contact with the head; and protective tape that has one end connected to an end portion of the recording tape and the other end connected to an end portion of the cleaning tape, and that has a length with which the protective tape is wound at least one round around the reel such that the recording tape and the cleaning tape do not contact each other.

In the tape recording medium of the first aspect, the cleaning tape is wound around the reel together with the recording tape. Here, the protective tape is intervened between the cleaning tape and the recording tape, and the protective tape is wound one round or more around the reel, so the cleaning tape is prevented from contacting the surface of the recording tape. Because of this, the recording tape is protected from the cleaning tape that cleans the head.

In this way, in the tape recording medium of the first aspect, the recording tape can be protected from the cleaning tape that is wound around the reel together with the recording tape.

An information recording system of a second aspect of the present invention comprises: a case; recording tape that is caused to travel inside the case by the rotation of a pair of reels disposed inside the case and at least one of writing and reading of information is performed with respect to the recording tape by a head disposed inside the case while the recording tape is in contact with the head; cleaning tape that is wound around the reels and cleans the head while the cleaning tape is in contact with the head; and protective tape that has one end connected to an end portion of the recording tape and the other end connected to an end portion of the cleaning tape, and that has a length with which the protective tape is wound at least one round around at least one of the pair of reels such that the recording tape and the cleaning tape do not contact each other.

In the information recording system of the second aspect, when information is written to or read from the recording tape, the recording tape is caused to travel by the rotation of the pair of reels. The head writes information on the recording tape or reads information already written on the recording tape while the head is in contact with the traveling recording tape. Additionally, when the cleaning tape that is wound around the reel together with the recording tape comes into contact with the head while traveling, the head is cleaned. Here, the protective tape is intervened between the cleaning tape and the recording tape, and the protective tape is wound one round or more around the reel, so the cleaning tape is prevented from contacting the surface of the recording tape. Because of this, the recording tape is protected from the cleaning tape that cleans the head.

In this way, in the information recording system of the second aspect, the recording tape can be protected from the cleaning tape that is wound around the reel together with the recording tape.

An information recording system pertaining to a third aspect of the present invention is the information recording system of the second aspect, wherein in a case where the protective tape is wound onto one reel of the pair of reels, the protective tape has a length with which the protective tape is wound at least one round around the one reel, and in a case where the protective tape is wound onto the other reel of the pair of reels, the protective tape has a length with which the protective tape is wound at least one round around the other reel.

In the information recording system of the third aspect, the protective tape is wound one round or more no matter which reel of the pair of reels the protective tape is wound around, so the cleaning tape is prevented from contacting the surface of the recording tape at both of the pair of reels.

A recording tape cartridge of a fourth aspect of the present invention comprises: a case; the tape recording medium of the first aspect, with the reel being rotatably disposed inside the case; and a leader member that is disposed on an end portion of the recording tape or the cleaning tape and is for withdrawing the recording tape and the cleaning tape from inside the case.

In the recording tape cartridge of the fourth aspect, the recording tape is withdrawn from the case inside a drive device, and information is written on the recording tape or information already written on the recording tape is read from the recording tape by a head inside the drive device. Additionally, when the cleaning tape that is wound around the reel together with the recording tape comes into contact with the head while traveling, the head is cleaned. Here, the protective tape is intervened between the cleaning tape and the recording tape, and the protective tape is wound one round or more around the reel, so the cleaning tape is prevented from contacting the surface of the recording tape. Because of this, the recording tape is protected from the cleaning tape that cleans the head.

In this way, in the recording tape cartridge of the fourth aspect, the recording tape can be protected from the cleaning tape that is wound around the reel together with the recording tape.

A tape recording medium of a fifth aspect of the present invention is the tape recording medium of the first aspect, wherein the protective tape is intervened between the recording tape and the cleaning tape in a state that the recording tape and the cleaning tape are wound around the reel, such that the recording tape and the cleaning tape do not contact each other.

An information recording system of a sixth aspect of the present invention is the information recording system of the third aspect, wherein the protective tape is intervened between the recording tape and the cleaning tape in a state that the recording tape and the cleaning tape are wound around either one reel of the pair of reels, such that the recording tape and the cleaning tape do not contact each other.

According to the fifth and sixth aspects, the cleaning tape and the recording tape are prevented from contacting each other by the protective tape. Because of this, the recording tape is protected from the cleaning tape that cleans the head.

As described above, the tape recording medium, the information recording system, and the recording tape cartridge pertaining to the present invention have the superior effect that they can protect recording tape from cleaning tape that is wound around a reel together with the recording tape.

### BRIEF DESCRIPTION OF DRAWINGS

FIG. 1 is a perspective view showing main portions of an information recording system pertaining to a first embodiment of the present invention;

FIG. 2 is a perspective view showing the schematic overall configuration of the information recording system pertaining to the first embodiment of the present invention;

FIG. 3 is a cross-sectional view schematically showing part of the information recording system pertaining to the first embodiment of the present invention;

FIG. 4A is a view showing a winding position of buffer tape in the information recording system pertaining to the first embodiment of the present invention and is a cross-sectional view schematically showing a state in which recording tape is completely rewound;

FIG. 4B is a view showing the winding position of the buffer tape in the information recording system pertaining to the first embodiment of the present invention and is a cross-sectional view schematically showing a state in which the recording tape is completely paid out; and

FIG. 5 is a perspective view showing a recording tape cartridge pertaining to a second embodiment of the present invention.

### DETAILED DESCRIPTION OF THE INVENTION

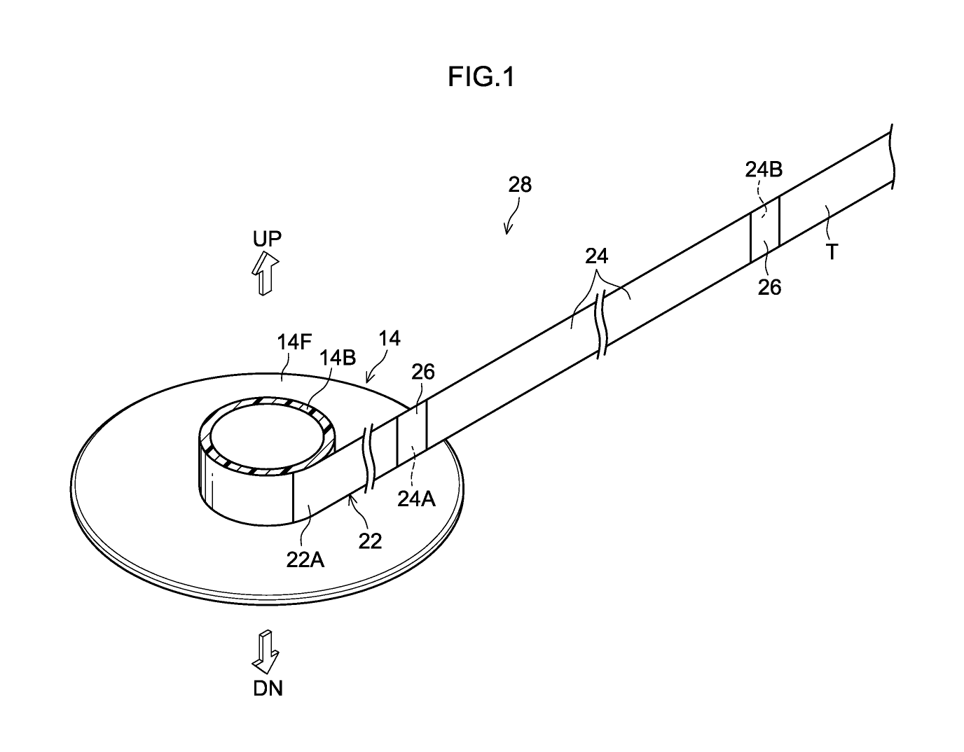

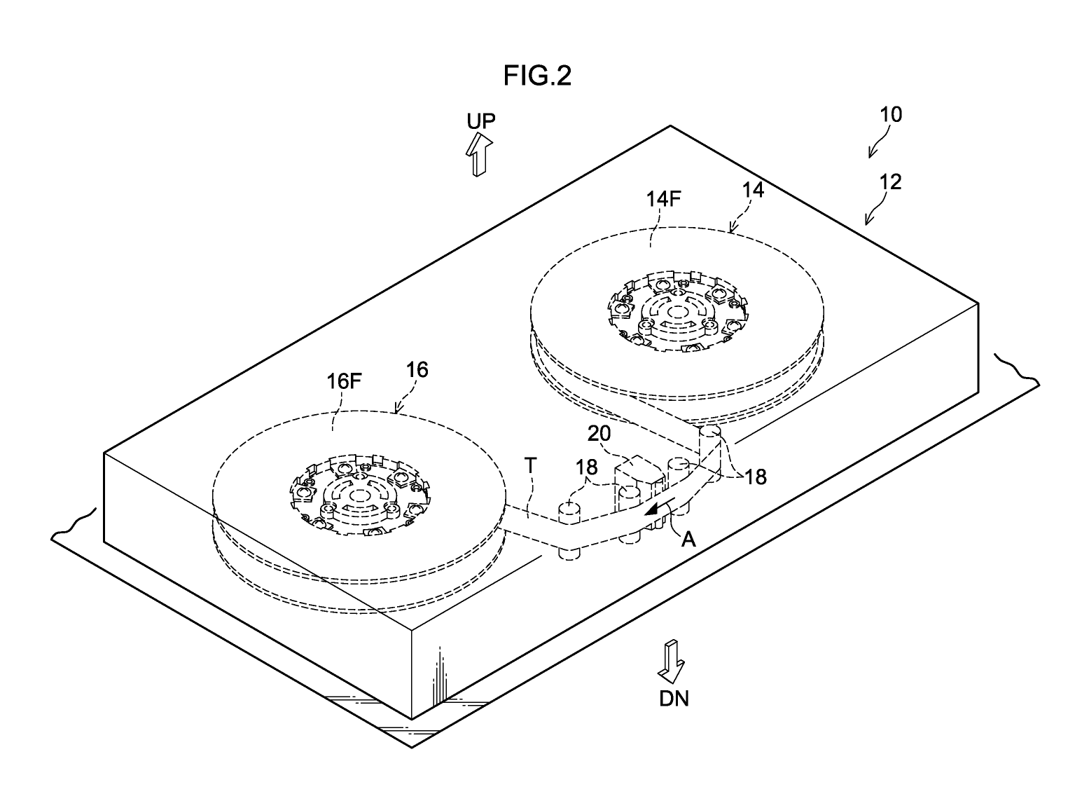

An information recording system 10 pertaining to a first embodiment of the present invention will be described on the basis of FIG. 1 to FIG. 4. For convenience of explanation, arrow UP in FIG. 2 denotes an up direction and arrow DN denotes a down direction.

### Schematic Overall Configuration of Information Recording System

As shown in FIG. 2, the information recording system 10 is equipped with a case 12 and a pair of reels 14 and 16 inside the case 12. An open portion for a user or the like to insert and remove the reels 14 and 16 is not formed in the case 12; rather, the reels 14 and 16 are always housed inside the case 12, including during the recording and playback of information and during storage.

Recording tape T such as magnetic tape that serves as an information recording and playback medium is wound around the reel 14 in such a way that the recording tape T can be paid out, and an end portion of the recording tape T is connected to the reel 16 such that the recording tape T can be taken up. In the information recording system 10, the recording tape T that has been paid out from the reel 14 rotating about an axis of rotation along the up-and-down direction is taken up by the reel 16 rotating about an axis of rotation along the up-and-down direction, and the recording tape T is rewound from the reel 16 onto the reel 14. That is, the reel 14 is a reel for paying out the recording tape T, the reel 16 is a reel for taking up the recording tape T, and the winding directions of the recording tape T onto these reels are opposite directions each other.

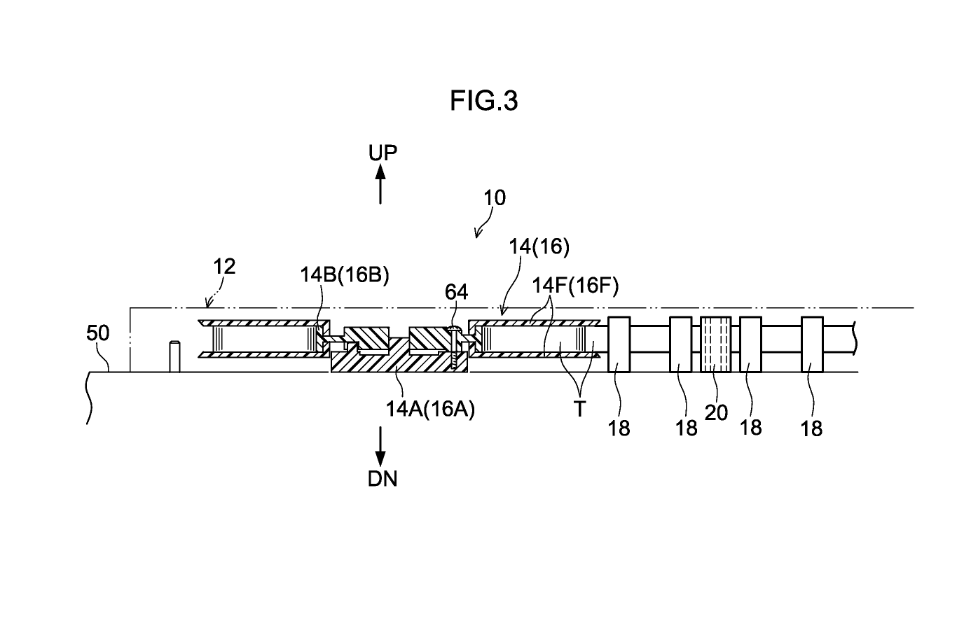

As shown in FIG. 3, the reels 14 and 16 are fixedly joined to, in such a way that they integrally rotate with, rotating members 14A and 16A disposed inside the case 12. FIG. 3 is a cross-sectional view schematically showing part of the information recording system 10. The rotating members 14A and 16A are directly coupled to unillustrated motors placed directly under them, and the rotating members 14A and 16A are synchronously driven to rotate such that the traveling speed of the recording tape T passing a later-described magnetic head 20 becomes substantially constant.

Further, as shown in FIG. 2 and FIG. 3, plural tape guides 18 are disposed inside the case 12, and the plural tape guides 18 define a traveling path for the recording tape T inside the case 12. A magnetic head 20 that serves as a head is disposed in a central portion (a section between two adjacent tape guides 18) of the traveling path of the recording tape T defined by the plural tape guides 18 inside the case 12. The magnetic head 20 is configured to perform at least one of recording of information on the recording tape T (writing) and playback of information already recorded on the recording tape T (reading).

In the information recording system 10 pertaining to this embodiment, the magnetic head 20 is configured to perform recording of information on the recording tape T and playback of information already recorded on the recording tape T while in sliding contact with the recording tape T traveling on the traveling path. As described above, the information recording system 10 is given a configuration that performs recording and playback of information with respect to the recording tape T in a range of recording capacity of the built-in recording tape T without replacing the recording tape T (the reels 14 and 16 around which the recording tape T is wound).

In the information recording system 10 in which insertion and removal of the recording tape T is not performed with respect to the case 12 in this way, as shown in FIG. 1, cleaning tape 22 for cleaning the magnetic head 20 is wound around the reel 14 together with the recording tape T inside the case 12. This will be specifically described below.

### Cleaning Tape and Protective Tape

In FIG. 1, the reel 14 (a later-described tape reel assembly 28) from which one flange 14F has been removed is shown in a perspective view. As shown in this drawing, the cleaning tape 22 has one end portion 22A fixedly held on a hub 14B of the reel 14 by adhesion or the like, for example, and the cleaning tape 22 is placed in a connected state that can withstand required tension in a predetermined tape pay-out. Consequently, the recording tape T is not directly connected to the hub 14B of the reel 14 but is connected to the hub 14B via the cleaning tape 22. The cleaning tape 22 is configured such that surface unevenness of the tape 22 is greater than that of the recording tape T in order to clean the magnetic head 20 by rubbing (sliding contact with) the magnetic head 20 while traveling.

As the cleaning tape 22, for example, tape obtained with the same material as the material of the recording tape T can be employed. However, a calendar process (subsequent process) that is a smoothing process when manufacturing the recording tape T is not performed for the cleaning tape 22. The cleaning tape 22 obtained in this way has a configuration where whose unevenness is greater on both its front and back sides compared to the recording tape T. The cleaning tape 22 has a length of 100 meters to several hundred meters, for example. The length of the recording tape T is several thousand meters or more.

Additionally, in the information recording system 10, as shown in FIG. 1, buffer tape 24 that serves as protective tape is disposed between the cleaning tape 22 and the recording tape T. Specifically, the buffer tape 24 has one lengthwise direction end portion 24A fixedly connected to the cleaning tape 22 via splice tape 26. Further, the buffer tape 24 has another lengthwise direction end portion 24B fixedly connected to the recording tape T via splice tape 26.

As the buffer tape 24, for example, tape obtained using the same material as that of the recording tape T can be employed. However, a servo writing process when manufacturing the recording tape T is not performed on the buffer tape 24. That is, the buffer tape 24 may have a configuration that differs from the recording tape T only in whether or not there are servo signals.

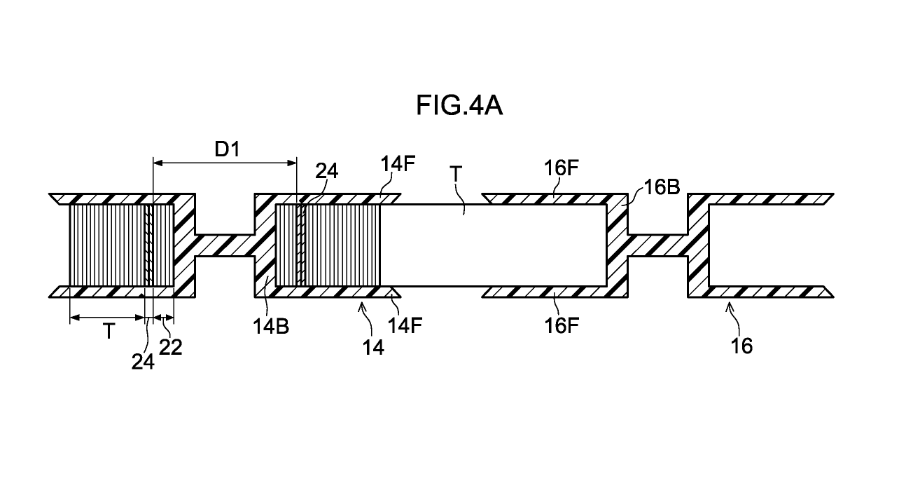

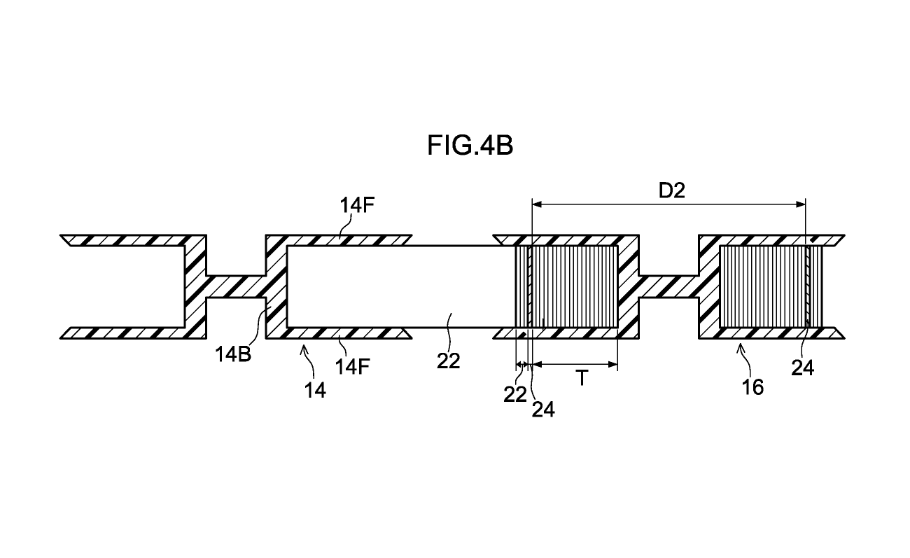

The buffer tape 24 has a length L with which the buffer tape 24 is wound one round or more around an outer periphery of the cleaning tape 22 as wound around the hub 14B. That is, as shown in FIG. 4A, when D1 represents a diameter of the outermost layer of the cleaning tape 22 in a state in which the cleaning tape 22 has been wound around the hub 14B, then L≧π×D1. Because of this, the recording tape T is wound around an outer periphery of the buffer tape 24 with respect to the hub 14B of the reel 14 without contacting the cleaning tape 22.

Moreover, the length L of the buffer tape 24 is decided in such a way that the buffer tape 24 can also be wound one round or more around an outer periphery of the recording tape T as taken up onto a hub 16B of the reel 16. That is, as shown in FIG. 4B, when D2 represents a diameter of the outermost layer of the recording tape T in a state in which the recording tape T has been taken up onto the hub 16B, then L≧π×D2. Because of this, the cleaning tape 22 is taken up onto the outer periphery of the buffer tape 24 with respect to the hub 16B of the reel 16 without contacting the recording tape T. In this embodiment, the diameter D2 is about twice the diameter D1.

The length L of the buffer tape 24 may be the length of the buffer tape 24 itself or may be understood as the length including installation ranges of the splice tape 26 on both ends. In other words, the splice tape 26 may be included as part of the protective tape in the present invention. In this embodiment, at least one of the reel 14 and the reel 16, the recording tape T, the cleaning tape 22, and the buffer tape 24 (the splice tape 26) configure a tape reel assembly 28 that serves as a tape recording medium in the present invention.

Next, function of the first embodiment will be described.

In the information recording system 10 of the above configuration, the reels 14 and 16 are synchronously driven to rotate when recording information on the recording tape T or playing back information from the recording tape T. Then, the recording tape T travels in the direction of arrow A (see FIG. 2) on the traveling path defined by the tape guides 18, and information is written on the recording tape T or information is read from the recording tape T by the magnetic head 20.

The magnetic head 20 becomes dirty because of this writing or reading of information. In a case where there is a request to remove this dirt, the reels 14 and 16 are synchronously driven to rotate in such a way that the cleaning tape 22 is paid out from the reel 14 and taken up onto the reel 16. Then, the cleaning tape 22 travels in the direction of arrow A on the traveling path defined by the tape guides 18, and the magnetic head 20 that has been rubbed by (come into sliding contact with) the traveling cleaning tape 22 is cleaned.

Further, when rewinding the cleaning tape 22 onto the reel 14 also, the cleaning tape 22 travels in the opposite direction of arrow A, and the magnetic head 20 that has been rubbed by (come into sliding contact with) the traveling cleaning tape 22 is cleaned.

Here, in the information recording system 10, the buffer tape 24 is intervened, one round or more around the hub 14B, between the cleaning tape 22 and the recording tape T as wound around the hub 14B of the reel 14. For this reason, the recording tape T does not contact with the surface of the cleaning tape 22 while receiving winding pressure. That is, the recording tape T is protected by the buffer tape 24 intervened between the recording tape T and the cleaning tape 22 such that the recording tape T does not contact the cleaning tape 22.

Because of this, in the information recording system 10, in a configuration where the pair of reels 14 and 16 and the magnetic head 20 are disposed inside the case 12 and they cannot be accessed (including insertion and removal) from the outside, the magnetic head 20 can be cleaned.

Further, in the information recording system 10, even in a case where the recording tape T has been taken up onto the hub 16B of the reel 16, the buffer tape 24 is intervened, one round or more around the hub 14B, between the recording tape T and the cleaning tape 22. For this reason, the recording tape T does not contact with the cleaning tape 22 and does not receive winding pressure from the cleaning tape 22. That is, the recording tape T is protected by the buffer tape 24 intervened between the recording tape T and the cleaning tape 22 such that the recording tape T does not contact the cleaning tape 22.

Consequently, in the information recording system 10, in any of a state in which the recording tape T is wound around the reel 14, a state in which the recording tape T is taken up onto the reel 16 (paid out from the reel 14), and an intermediate state between these, the recording tape T does not come into contact with the cleaning tape 22 while receiving winding pressure.

In this way, in the information recording system 10 pertaining to the present embodiment, the recording tape T can be protected from the cleaning tape 22 that is wound around the reels 14 and 16 together with the recording tape T.

In the first embodiment, an example was described where the end portion of the cleaning tape 22 was connected to the hub 14B of the reel 14 on the pay-out side, but the present invention is not limited to this and may also be configured in such a way that, for example, one end portion of the recording tape T is connected to (held on) the hub 14B of the reel 14 and the buffer tape 24 is intervened between the other end portion of the recording tape T and the cleaning tape 22.

### Second Embodiment

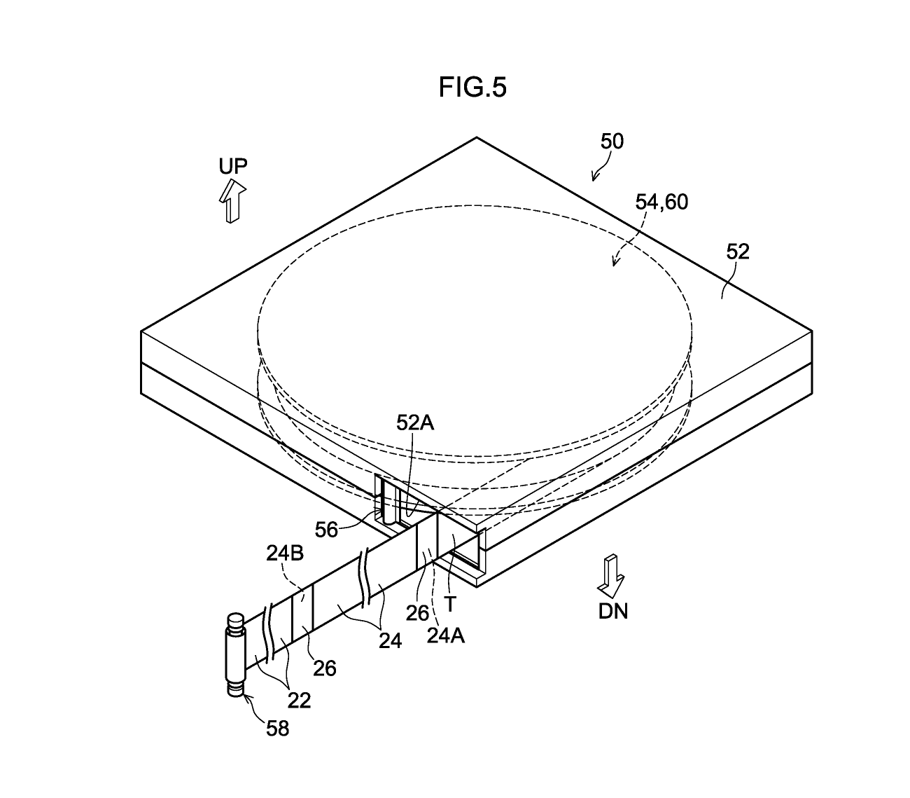

Next, a recording tape cartridge 50 pertaining to a second embodiment of the present invention will be described on the basis of FIG. 5.

In FIG. 5, the schematic overall configuration of the recording tape cartridge 50 is shown in a perspective view. As shown in this drawing, the recording tape cartridge 50 is configured in such a way that a single reel 54, around which the recording tape T is wound, is rotatably housed inside a case 52. An opening 52A for withdrawing the recording tape T is formed in the case 52, and the opening 52A is opened and closed by a door 56.

The recording tape cartridge 50 is configured such that, when the recording tape cartridge 50 is loaded into a drive device, the opening 52A that had been closed by the door 56 is opened and the recording tape T is withdrawn from the case 52 inside the drive device. The recording tape T that has been withdrawn inside the drive device travels while being taken up onto an unillustrated take-up reel configuring the drive device, and information is recorded or played back while the recording tape T is in sliding contact with a magnetic head inside the drive device.

Additionally, the cleaning tape 22 and the buffer tape 24 are wound around the reel 54 together with the recording tape T. In this embodiment, the end portion of the recording tape T is fixedly held on an unillustrated hub of the reel 54, and the cleaning tape 22 is connected via the buffer tape 24 to the withdrawal (pay-out) end side of the recording tape T.

Specifically, the withdrawal end of the recording tape T is fixedly connected by the splice tape 26 to the one end portion 24A of the buffer tape 24, and the one end portion of the cleaning tape 22 is fixedly connected by the splice tape 26 to the other end portion 24B of the buffer tape 24. In this embodiment, a leader pin 58 that serves as a leader member that is operated when the recording tape T is withdrawn by the drive device is attached to the other end portion of the cleaning tape 22.

The buffer tape 24 has a length L with which the buffer tape 24 is wound one round or more around the outer periphery of the recording tape T as wound around the hub of the reel 54. Although it is not shown in the drawings, when D3 represents the diameter of the outermost layer of the recording tape T in a state in which the recording tape T has been wound around the hub of the reel 54, then L≧π×D3. Because of this, the cleaning tape 22 is wound around (the outer periphery of) the buffer tape 24 with respect to the hub of the reel 54.

Moreover, the length L of the buffer tape 24 is decided in such a way that the buffer tape 24 can also be wound one round or more around the outer periphery of the cleaning tape 22 as taken up onto a hub of the take-up reel of the drive device. In this embodiment, the diameter of the hub of the reel 54 and the diameter of the hub of the take-up reel of the drive device are configured to be about the same. Accordingly, due to the relationship of the lengths (winding diameters) of the cleaning tape 22 (about 100 meters or more) and the recording tape T (several thousand meters or more), by satisfying L≧π×D3, it is ensured that the length L of the buffer tape 24 is sufficient so as also to be wound one round or more around the outer periphery of the cleaning tape 22 as taken up onto the hub of the take-up reel of the drive device.

The length L of the buffer tape 24 may be the length of the buffer tape 24 itself or may be understood that the length L includes installation ranges of the splice tape 26 on both ends. In other words, the splice tape 26 may be included as part of the protective tape in the present invention. In this embodiment, the reel 54, the recording tape T, the cleaning tape 22, and the buffer tape 24 (the splice tape 26) configure a tape reel assembly 60 that serves as a tape recording medium in the present invention.

Next, the function of the second embodiment will be described.

The recording tape cartridge 50 is loaded into the drive device when recording information on the recording tape T or playing back information from the recording tape T. Then, in accompaniment with this loading action, the door 56 is moved from the position in which it closes the opening 52A to the position in which it opens the opening 52A, and the opening 52A is maintained to be open. Next, the drive device grips the leader pin 58, guides the leading end of the cleaning tape 22 to the take-up reel, and causes the take-up reel in which the leader pin 58 has been set to rotate synchronously with the reel 54.

Because of this, the cleaning tape 22 is paid out from the reel 54, travels while being withdrawn from the case 52, and cleans the magnetic head of the drive device while rubbing the magnetic head. When the cleaning tape 22 passes the magnetic head, the recording tape T comes into sliding contact with the magnetic head and information is recorded or played back. Moreover, when rewinding the recording tape T onto the reel 54 also, the cleaning tape 22 travels in the opposite direction of the direction during the withdrawal of the recording tape T, and the magnetic head 20 is cleaned by being rubbed by (come into sliding contact with) the traveling cleaning tape 22.

Here, in the recording tape cartridge 50, the buffer tape 24 is intervened, one round or more around the hub of the reel 54, between the cleaning tape 22 and the recording tape T as wound around the hub of the reel 54. For this reason, the recording tape T does not contact with the cleaning tape 22 and does not receive winding pressure from the cleaning tape 22. That is, the recording tape T is protected by the buffer tape 24 intervened between the recording tape T and the cleaning tape 22 such that the recording tape T does not contact the cleaning tape 22.

In this way, in the recording tape cartridge 50 pertaining to the present embodiment, the recording tape T can be protected from the cleaning tape 22 that is wound around the reel 54 together with the recording tape T.

Further, in the recording tape cartridge 50, even in a case where the recording tape T has been taken up onto the hub of the take-up reel on the drive device side, the buffer tape 24 is intervened, one round or more around the take-up reel, between the recording tape T and the cleaning tape 22. For this reason, the recording tape T does not contact with the surface of the cleaning tape 22 while receiving winding pressure. That is, the recording tape T is protected by the buffer tape 24 intervened between the recording tape T and the cleaning tape 22 such that the recording tape T does not contact the cleaning tape 22.

Consequently, in the recording tape cartridge 50, in any of a state in which the recording tape T is wound around the reel 54, a state in which the recording tape T is taken up onto the take-up reel of the drive device (paid out from the reel 54), and an intermediate state between these states, the recording tape T does not come into contact with the cleaning tape 22 while receiving winding pressure.

In the second embodiment, an example was described where the cleaning tape 22 was connected to withdrawal end side of the recording tape T, but the present invention is not limited to this and may also be given a configuration where, for example, the cleaning tape 22 is fixedly connected to the hub of the reel 54. That is, the present invention may also be given a configuration where the recording tape T is held on the reel 54 via the cleaning tape 22 and the buffer tape 24.

The disclosure of Japanese Patent Application No. 2011-032185 is incorporated in its entirety by reference in the present specification.

All publications, patent applications, and technical standards mentioned in the present specification are herein incorporated by reference to the same extent as if each individual publication, patent application, or technical standard was specifically and individually indicated to be incorporated by reference.

What is claimed is:

1. A tape recording medium comprising:
a reel;
recording tape that is wound around the reel and on which information is written or from which information is read while the recording tape is in contact with a head;
cleaning tape that is wound around the reel and cleans the head while the cleaning tape is in contact with the head; and
protective tape that has one end connected to an end portion of the recording tape and the other end connected to an end portion of the cleaning tape, and that has a length with which the protective tape is wound at least one round around the reel such that the recording tape and the cleaning tape do not contact each other.

2. An information recording system comprising:
a case;
recording tape that is caused to travel inside the case by rotation of a pair of reels disposed inside the case, and at least one of writing and reading of information is performed with respect to the recording tape by a head disposed inside the case while the recording tape is in contact with the head;
cleaning tape that is wound around the reels and cleans the head while the cleaning tape is in contact with the head; and
protective tape that has one end connected to an end portion of the recording tape and the other end connected to an end portion of the cleaning tape, and that has a length with which the protective tape is wound at least one round around at least one of the pair of reels such that the recording tape and the cleaning tape do not contact each other.

3. The information recording system according to claim 2, wherein in a case where the protective tape is wound onto one reel of the pair of reels, the protective tape has a length with which the protective tape is wound at least one round around the one reel, and in a case where the protective tape is wound onto the other reel of the pair of reels, the protective tape has a length with which the protective tape is wound at least one round around the other reel.

4. A recording tape cartridge comprising:
a case;
the tape recording medium according to claim 1, with the reel being rotatably disposed inside the case; and
a leader member that is disposed on an end portion of the recording tape or the cleaning tape and is for withdrawing the recording tape and the cleaning tape from inside the case.

5. The tape recording medium according to claim 1, wherein the protective tape is intervened between the recording tape and the cleaning tape in a state that the recording tape and the cleaning tape are wound around the reel, such that the recording tape and the cleaning tape do not contact each other.

6. The information recording system according to claim 3, wherein the protective tape is intervened between the recording tape and the cleaning tape no matter which reel of the pair of reels the recording tape and the cleaning tape are wound around, such that the recording tape and the cleaning tape do not contact each other.
